(19) United States
(12) Patent Application Publication
(10) Pub. No.: US 2025/0013857 A1
(43) Pub. Date: Jan. 9, 2025

(54) PROGRAM CODE GENERATION FOR THE ACCELERATION OF NEURAL NETWORKS

(71) Applicant: Robert Bosch GmbH, Stuttgart (DE)

(72) Inventors: Duy Khoi Vo, Stuttgart (DE); Benjamin Wagner, Friedrichshafen (DE); Dennis Sebastian Rieber, Albstadt (DE); Sebastian Boblest, Duernau (DE); Ulrik Hjort, Malmö (SE); Walid Hussien, Fellbach (DE)

(21) Appl. No.: 18/739,884

(22) Filed: Jun. 11, 2024

(30) Foreign Application Priority Data
Jul. 3, 2023 (DE) 10 2023 206 289.5

(51) Int. Cl. G06N 3/048

(52) U.S. Cl. CPC G06N 3/048

(57) ABSTRACT

A method for generating program code which, when executed on a hardware platform, creates a neural network having a given architecture. In the method: for at least one layer and/or group of neurons, a non-linear activation function of the neurons in that layer and/or group is ascertained from the given architecture; possible values that can be assumed by the activation function are precalculated and stored in a lookup table; program code is generated which, for all neurons in the layer and/or group respectively: aggregates the inputs of the respective neuron to form an argument of the activation function in accordance with the given architecture, ascertains an index from this argument, under which the associated value of the activation function is stored in the lookup table for the respective layer or group, and ascertains the output of the neuron by retrieving the value from the lookup table with this index.

### CROSS REFERENCE

The present application claims the benefit under 35 U.S.C. § 119 of German Patent Application No. DE 10 2023 206 289.5 filed on Jul. 3, 2023, which is expressly incorporated herein by reference in its entirety.

### FIELD

The present invention relates to the implementation of neural networks for operation on a hardware platform, such as a microcontroller or control unit.

### BACKGROUND INFORMATION

More and more devices that are controlled by microcontrollers and other embedded systems are provided with additional functionality through the use of neural networks. The processing of data, and here in particular measurement data acquired by means of sensors, with neural networks is comparatively complex. Expanding or strengthening the hardware platform being used is not always readily possible. Aside from the fact that this increases manufacturing costs, the installation space, the power consumption, and/or the heat generation are often limited. In such cases, the existing hardware platform has to be accepted as a given. The only remaining option to speed up the data processing is then the efficiency of processing.

A significant part of the effort involved in the processing of neural networks goes into the evaluation of so-called activation functions. In many neural networks, inputs provided to each neuron are summed with weighting and the output of the neuron is ascertained from the result by the application of the activation function. This activation function is always non-linear. The evaluation of some activation functions can be accelerated by retrieving precalculated results from a lookup table. Examples of this are described in U.S. Pat. No. 11,361,213 B1 and U.S. Patent Application Publication No. US 2021/132 954 A1.

### SUMMARY

The present invention provides a method for generating program code to create a neural network having a given architecture. The neural network is created when the generated program code is executed on a hardware platform. The given architecture comprises neurons organized in layers and/or other groups. Neurons of a layer within a stack of multiple layers can receive the outputs of a preceding layer as inputs and provide their own outputs to the neurons of a subsequent layer as inputs, for example. An input layer can receive the inputs of the neural network as a whole, and an output layer can output the outputs of the neural network as a whole.

According to an example embodiment of the present invention, as part of the method, a non-linear activation function of the neurons in the layer and/or group is ascertained for at least one layer and/or group of neurons from the given architecture. Possible values that can be assumed by the activation function are precalculated and stored in a lookup table. This means that, unlike in previously known solutions, there is no longer only one lookup table, but rather the lookup table is specific to the respective layer and/or group of neurons. The program code for processing the entire neural network therefore overall includes a plurality of lookup tables.

Program code is now generated that implements the processing of the inputs of all neurons of the layer and/or group to corresponding outputs.

More specifically, this program code aggregates the inputs of the respective neuron to form an argument of the activation function in accordance with the given architecture. From this argument, the program code ascertains an index under which the associated value of the activation function is stored in the lookup table for the respective layer or group.

The program code then ascertains the output of the neuron by retrieving the value from the lookup table with this index. This completes the processing of the inputs of the respective neuron.

Maintaining a lookup table for each layer and/or group, and thus many lookup tables, takes additional memory. However, there are two advantages in return for this additional memory. On the one hand, the flexibility is increased in that lookup tables can also be used to create architectures in which not all neurons use the exact same activation function. On the other hand, it makes it easier to retrieve values from the lookup table. Since the lookup table is specific to the respective layer or group, there is a comparatively simple relationship between the argument of the activation function and the index at which the appropriate value of the activation function is stored. Accordingly, the time required to retrieve the value from the lookup table is not increased by a complicated calculation of the index, or even by a search in the lookup table. Lastly, the whole point of the lookup table is to save time over a direct calculation of the value of the activation function.

The generation of lookup tables at the time of code generation as opposed to the provision of lookup tables in libraries generally has the advantage that the ultimately generated program code contains only those lookup tables that are actually used to process the specifically given neural network. In contrast, a library function that implements an activation function using internal lookup tables, for example, has to be loaded into the memory complete with all of these lookup tables. Since libraries are usually created for many use cases, only a few of these lookup tables would be needed for a specific application. If, for example, an activation function dependent on free parameters with internal lookup tables is provided as a library function, as will be explained in more detail later, lookup tables for all possible combinations of the free parameters of the activation function have to be calculated and provided for the library. This would make the source code of the library huge. It would also make using the library extremely laborious, because the user would have to select the correct lookup table for each layer manually. If the linker used to finalize the implementation of the neural network does not remove unused lookup tables, the final program code will be very large as well.

In a particularly advantageous embodiment of the present invention, program code is generated which calculates the argument of the activation function in integer arithmetic. Aside from the fact that integers can per se be calculated faster than floating-point numbers, integers can also be easily converted into integer indices and thus memory addresses of values of the activation function.

In a further particularly advantageous embodiment of the present invention, program code is generated which calculates the index by adding an offset to the argument. For example, if working throughout with integers that can take values between −128 and +127, an offset of 128 can be added. An argument of −128 is then mapped to the index 0 and therefore to the start of the lookup table. An argument of +127 is mapped to the index 255 and therefore to the end of the lookup table. Obtaining a value of the activation function is thus reduced to the combination of adding the offset and accessing the lookup table in the memory.

In a further particularly advantageous embodiment of the present invention, the values of the activation function are stored in the lookup table as integers. They can then be used directly as inputs for the next neuron, which in turn works with integer arithmetic. Hardware platforms that do not have a floating-point arithmetic unit can moreover also be used to execute the generated program code.

In a particularly advantageous embodiment of the present invention, an integer arithmetic with 256 possible values is selected. As discussed above, these can in particular be signed int8 values from −128 to +127, for instance. 256 possible values have in practice proven to be a very good compromise between the best possible accuracy on the one hand and the lowest possible memory requirement for lookup tables on the other hand. If even better accuracy is desired, enlarging the architecture of the neural network and providing more neurons offers a better cost-benefit ratio than switching the arithmetic to the next larger class of integers (e.g. int16).

In a further particularly advantageous embodiment of the present invention, program code is generated which approximates at least one multiplication with a non-integer factor by the combination of a multiplication by an integer factor and subsequent bit-by-bit shifting. Multiplication by a floating-point factor can thus be approximated even on a hardware platform that does not have a floating-point arithmetic unit.

This can, for example, in particular be used to take into account parameters that are not necessarily integers in the context of the activation function.

An activation function with a free parameter the value of which is the same within each group and/or layer of neurons can be selected, for instance. A new lookup table is then required for each value of this free parameter. It is thus possible, for example, to specifically form groups of neurons according to which neurons have the same activation functions with the same values of the free parameters.

In a further advantageous embodiment of the present invention, program code is generated which respectively adds an offset when forming the argument of the activation function and/or when ascertaining the output of the neuron. This offset is then the same within each group and/or layer of neurons. For example, groups of neurons can be selected specifically according to the neurons for which the combination of
input offsets and/or output offsets,
type of activation function and,
if applicable, values of the free parameters of this activation function
   is respectively identical. In each case, the lookup table is specific to this combination.

If a quantization of the neural network for execution in integer arithmetic still depends on further parameters, such as a multiplier and/or a number of bits (shift) for bit-by-bit shifting when converting between floating-point numbers and integers, the lookup table can be specific to these parameters as well. In other words, if the quantization parameters change during the transition from one layer and/or group of neurons to the next, a new lookup table is required.

In a particularly advantageous embodiment of the present invention, the leaky rectified linear unit (Leaky ReLU) which outputs positive arguments unchanged and multiplies negative arguments by a predetermined factor α is selected as the activation function. This activation function is advantageous in particular in cases in which the normal rectified linear unit (ReLU), which instead maps negative arguments to 0, can make training more difficult due to the constant subfunction for negative arguments because of the gradients that then vanish. The Leaky ReLU is furthermore increasingly used especially in very small neural networks that are used in quantized form on microcontrollers.

In a further particularly advantageous embodiment of the present invention, program code is generated which includes a pointer to the lookup table. The storage of the many lookup tables in the memory can thus be designed with maximum flexibility. It is in particular only known at the time the program code is generated under the boundary condition of any set input offsets, output offsets and/or free parameters of activation functions how many different lookup tables are required and which values have to be contained in them, i.e., the lookup tables are calculated when the program code is generated.

In a large neural network, there can be many different combinations of input offsets, output offsets, and free parameters for activation functions, for example the gain factor α for the Leaky ReLU as the activation function. Each such combination requires its own lookup table for the values of the activation function. If the overall memory requirement for this becomes too large, a part of the memory can be reduced by giving up some of the acceleration by recalculating those activation functions that are called only relatively rarely in the conventional, slower way each time they are called. If one ignores the fact that parallel processing of multiple data with one instruction (single instruction, multiple data, SIMD) may be possible on the hardware platform, the computational effort for the evaluation of the activation function, for example in a layer of neurons, is measured in a first approximation according to the size of the input vector that is fed to this layer. Layers that process comparatively short input vectors, for example, can therefore evaluate the activation function according to the standard implementation, which recalculates the value each time it is called. Layers that process longer input vectors, on the other hand, can use lookup tables. The memory requirement for the respective lookup table does not depend on the length of the input vectors.

Thus, in a further particularly advantageous embodiment of the present invention, those layers and/or groups for which a lookup table and program code for retrieving values of an activation function from this lookup table are produced are selected from the total existing layers and/or groups of the neural network based on the computational effort incurred in the respective group and/or layer for the evaluation of the activation function.

In a further particularly advantageous embodiment of the present invention, the program code is loaded onto a hardware platform and executed, so that the neural network is created. As discussed above, the neural network is then processed more quickly with the same computing power of the hardware platform at the cost of increasing the memory requirement by the lookup tables. The method can therefore, for instance, in particular be used to better utilize a hardware platform on which the computing capacity is limited but sufficient memory is still available.

In a further particularly advantageous embodiment of the present invention, the neural network is supplied with measurement data that has been recorded by at least one sensor. The neural network is used to ascertain outputs with respect to a given task from these measurement data.

For this purpose, according to an example embodiment of the present invention, the neural network can in particular be trained with training data labeled with associated target outputs relating to the given task, for example. During such training, the training data can be processed by the neural network into outputs and these outputs can be compared with the respective target outputs. The deviations resulting from this comparison can be evaluated with a cost function. For instance, weights with which the inputs of the respective neuron are aggregated to form an argument of the activation function, or also other parameters that characterize the behavior of the neural network, can be optimized with the objective of improving the evaluation by the cost function. The training enables the neural network to also generalize to measurement data that was not seen during training.

According to an example embodiment of the present invention, a control signal is ascertained from the outputs generated by the neural network from the measurement data. This control signal is used to control a vehicle, a driving assistance system, a robot, a system for monitoring areas, a system for quality control and/or a system for medical imaging. This increases the probability that the reaction of the respective technical system carried out to the control with the control signal is appropriate to the situation embodied in the measurement data.

The neural network can in particular be configured as an image classifier, for example, that assigns classification scores to images as measurement data, or portions of these images, with respect to one or more classes of a given classification.

The method can in particular be fully or partly computer-implemented. The present invention therefore also relates to a computer program comprising machine-readable instructions, which, when they are executed on one or more computers, cause the computer(s) to carry out the described method. In this sense, control units for vehicles and embedded systems for technical devices that are likewise capable of executing machine-readable instructions are also considered to be computers.

The present invention furthermore also relates to a machine-readable data carrier and/or to a download product comprising said computer program. A download product is a digital product that can be transmitted via a data network, i.e., can be downloaded by a user of the data network, and can be offered for sale in an online shop for immediate download, for example.

According to an example embodiment of the present invention, a computer can moreover be equipped with the computer program, with the machine-readable data carrier or with the download product.

Further measures improving the present invention are shown in more detail below, together with the description of the preferred embodiment examples of the present invention, with reference to the figures.

### BRIEF DESCRIPTION OF THE DRAWINGS

FIG. 1 shows an embodiment example of the method 100 for generating program code 10 to create a neural network 2 on a hardware platform 1, according to the present invention.

FIG. 2 shows embodiment example of the selection of layers 3* for the creation of lookup tables 6a-6f on a neural network 2, according to an example embodiment of the present invention.

### DETAILED DESCRIPTION OF EXAMPLE EMBODIMENTS

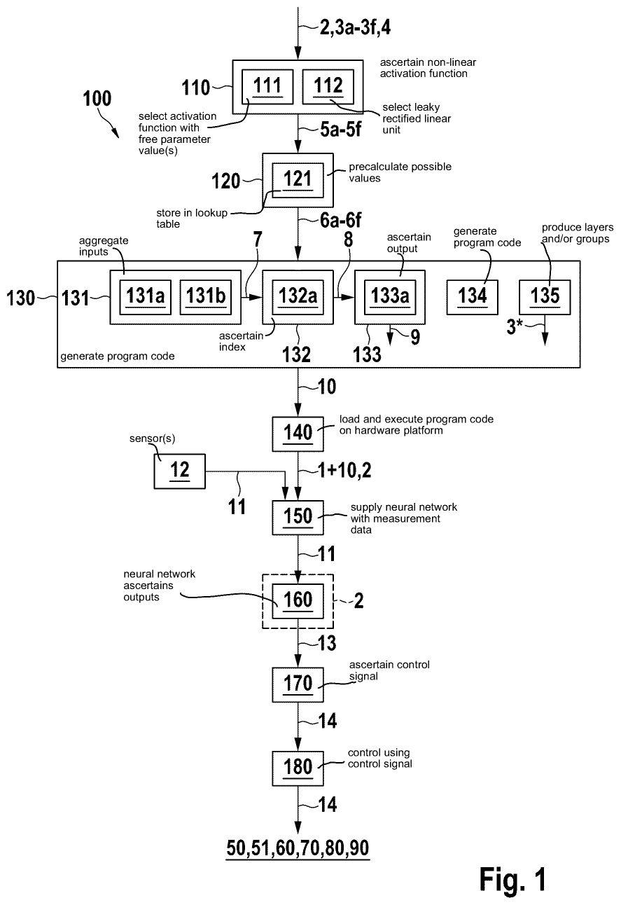

FIG. 1 is a schematic flowchart of an embodiment example of the method 100 for generating program code 10 that, when executed on a hardware platform 1, creates a neural network 2 having a given architecture. The given architecture of the neural network 2 is that which sets the number of neurons 4 and their organization in layers and/or other groups 3a-3f.

In step 110, a non-linear activation function 5a-5f of the neurons 4 in the layer and/or group 3a-3f is ascertained for at least one layer and/or group 3a-3f of neurons 4 from the given architecture.

According to block 111, an activation function 5a-5f with at least one free parameter the value of which is the same within each group and/or layer 3a-3f of neurons 4 can be selected.

According to block 112, the leaky rectified linear unit which outputs positive arguments unchanged and multiplies negative arguments by a predetermined factor α is selected as the activation function 5a-5f.

In step 120, possible values that can be assumed by the activation function 5a-5f are precalculated and stored in a lookup table 6a-6f.

According to block 121, the values of the activation function 5a-5f can be stored in the lookup table 6a-6f as integers.

In step 130, program code for implementing the neurons 4 in the layer and/or group 3a-3f is generated.

According to block 131, this program code aggregates the inputs of the respective neuron 4 to form an argument 7 of the activation function 5a-5f in accordance with the given architecture. According to block 132, it also ascertains an index 8 from this argument 7, under which the associated value of the activation function 5a-5f is stored in the lookup table 6a-6f for the respective layer or group 3a-3f. According to block 133, the program code 10 ultimately ascertains the output 9 of the neuron 4 by retrieving the value from the lookup table 6a-6f with this index 8.

According to block 131a, program code 10 can in particular be generated which calculates the argument 7 of the activation function 5a-5f in integer arithmetic. In this case, for instance, it is in particular possible to select an integer arithmetic with 256 possible values.

According to block 131b, program code 10 can be generated which respectively adds an offset that is the same for all neurons 4 within the group and/or layer 3a-3f when forming the argument 7 of the activation function 5a-5f.

According to block 132a, program code 10 can be generated which calculates the index 8 by adding an offset to the argument 7.

According to block 133a, program code 10 can be generated which respectively adds an offset that is the same for all neurons 4 within the group and/or layer 3a-3f when forming the output 9 of the neuron 4.

According to block 134, program code 10 can be generated which includes a pointer to the lookup table 6a-6f.

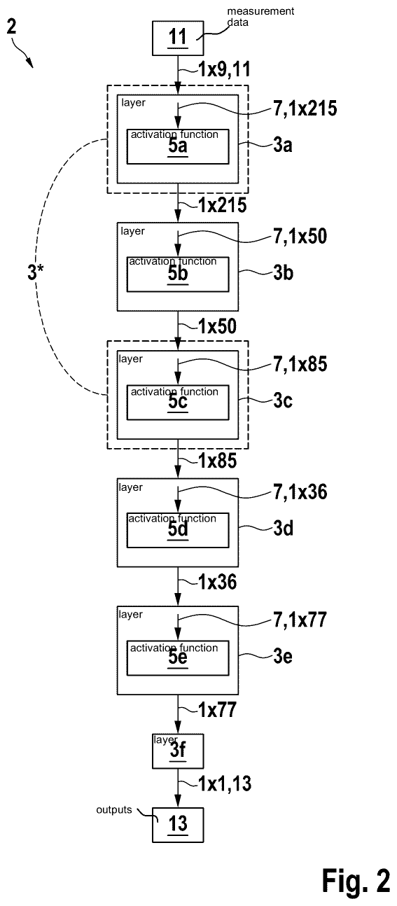

According to block 135, those layers and/or groups 3* for which a lookup table 6a-6f and program code 10 for retrieving values of an activation function 5a-5f from this lookup table 6a-6f are produced can be selected from the total existing layers and/or groups 3a-3f of the neural network (2) based on the computational effort incurred in the respective group and/or layer 3a-3f for the evaluation of the activation function 5a-5f. This is explained in more detail in FIG. 2.

In the example shown in FIG. 1, the program code 10 is loaded onto a hardware platform 1 in step 140 and executed, so that neural network 2 is created.

In step 150, the neural network 2 is then supplied with measurement data 11 recorded by at least one sensor 12. In step 160, the neural network 2 ascertains outputs 13 with respect to a given task from these measurement data 11.

In Step 170, a control signal 14 is ascertained from the thus obtained outputs 13. In step 180, a vehicle 50, a driving assistance system 51, a robot 60, a system 70 for monitoring areas, a system 80 for quality control and/or a system 90 for medical imaging is controlled by means of the control signal 14.

FIG. 2 shows an example of an architecture of a neural network 2 on which the method 100 can be carried out. In the example shown in FIG. 2, layers 3* are selected, in particular based on the computational effort, for which lookup tables 6a-6f and associated program code 10 are even being created.

The neural network 11 processes inputs 11, which are present as a 1×9 vector, into outputs 13 that contain only one number (1×1 vector). The neural network 11 comprises six layers 3a-3f. In the example shown in FIG. 2, these layers are all fully networked layers, in which each neuron 4 has all of the outputs of the respective preceding layer available as inputs.

The first layer 3a has an activation function 5a that expects a 1×215 vector as the argument 7. It outputs a 1×215 vector to the second layer 3b.

The second layer 3b has an activation function 5b that expects a 1×50 vector as the argument 7. It outputs a 1×50 vector to the third layer 3c.

The third layer 3c has an activation function 5c that expects a 1×85 vector as the argument 7. It outputs a 1×85 vector to the fourth layer 3d.

The fourth layer 3d has an activation function 5d that expects a 1×36 vector as the argument 7. It outputs a 1×36 vector to the fifth layer 3e.

The fifth layer 3e has an activation function 5e that expects a 1×77 vector as the argument 7. It outputs a 1×77 vector to the sixth layer 3f.

The sixth layer 3f compresses this 1×77 vector directly into the 1×1 output 13.

The effort required to calculate the activation functions 5a-5e depends substantially on the length of the inputs to be processed, because the evaluation of the activation function 5a-5e has to be repeated for each element of the input. The longer the respective input, the more time can be saved by evaluating it using the lookup tables 6a-6e. The memory requirement per lookup table 6a-6e, on the other hand, is independent of the length of the inputs.

In the example shown in FIG. 2, the two layers 3a and 3c, which account for 64.8% of the total computational effort for the calculation of the activation functions 5a-5e, were selected as the layers 3* for which the activation functions 5a or 5c are implemented with the lookup tables 6a and 6c and the associated program code 10. This requires only 40% of the additional memory that would be needed to implement all of the activation functions 5a-5e with the lookup tables 6a-6e. The selection 3* shown in FIG. 2 is thus a good compromise between acceleration of the processing on the one hand and the memory overhead on the other hand.

What is claimed is:

1. A method for generating program code which, when executed on a hardware platform, creates a neural network having a given architecture, wherein the given architecture includes neurons organized in layers and/or groups, the method comprising the following steps:
for at least one layer and/or group of neurons, ascertaining a non-linear activation function of the neurons in the layer and/or group from the given architecture;
pre-calculating and storing in a lookup table possible values that can be assumed by the activation function;
generating program code which, for all respective neurons in the layer and/or group respectively:
aggregates inputs of the respective neuron to form an argument of the activation function in accordance with the given architecture,
ascertains an index from the argument, under which an associated value of the activation function is stored in the lookup table for the respective layer and/or group, and
ascertains an output of the respective neuron by retrieving the value from the lookup table with the index.

2. The method according to claim 1, wherein program code is generated which calculates the argument of the activation function in integer arithmetic.

3. The method according to claim 2, wherein program code is generated which calculates the index by adding an offset to the argument.

4. The method according to claim 2, wherein values of the activation function are stored in the lookup table as integers.

5. The method according to claim 2, wherein the integer arithmetic is an integer arithmetic with 256 possible values.

6. The method according to claim 1, wherein the activation function is an activation function with at least one free parameter a value of which is the same within each layer and/or group of neurons.

7. The method according to claim 1, wherein:
program code is generated which respectively adds an offset when forming the argument of the activation function and/or when ascertaining the output of the neuron, and
the offset is the same within each layer and/or group of neurons.

8. The method according to claim 1, wherein the activation function is a leaky rectified linear unit which outputs positive arguments unchanged and multiplies negative arguments by a predetermined factor.

9. The method according to claim 1, wherein program code is generated which includes a pointer to the lookup table.

10. The method according to claim 1, wherein, from a total existing layers and/or groups of the neural network, those layers and/or groups for which a lookup table and program code for retrieving values of an activation function from the lookup table are produced are selected based on a computational effort incurred in the respective group and/or layer for an evaluation of the activation function.

11. The method according to claim 1, wherein the program code is loaded onto a hardware platform and executed, so that the neural network is created.

12. The method according to claim 11, wherein:
the neural network is supplied with measurement data recorded by at least one sensor,
the neural network ascertains outputs with respect to a given task from the measurement data,
a control signal is ascertained from the outputs, and
a vehicle, and/or a driving assistance system, and/or a robot, and/or a system for monitoring areas, and/or a system for quality control, and/or a system for medical imaging, is controlled using the control signal.

13. A non-transitory machine-readable data carrier on which is stored a computer program including machine-readable instructions for generating program code which, when executed on a hardware platform, creates a neural network having a given architecture, wherein the given architecture includes neurons organized in layers and/or groups, the instructions, when executed by one or more computers and/or compute instances, causing the one or more computers and/or compute instances to perform the following steps:
for at least one layer and/or group of neurons, ascertaining a non-linear activation function of the neurons in the layer and/or group from the given architecture;
pre-calculating and storing in a lookup table possible values that can be assumed by the activation function;
generating program code which, for all respective neurons in the layer and/or group respectively:
aggregates inputs of the respective neuron to form an argument of the activation function in accordance with the given architecture,
ascertains an index from the argument, under which an associated value of the activation function is stored in the lookup table for the respective layer and/or group, and
ascertains an output of the respective neuron by retrieving the value from the lookup table with the index.

14. One or more computers and/or compute instances including a non-transitory data carrier on which is stored a computer program including machine-readable instructions for generating program code which, when executed on a hardware platform, creates a neural network having a given architecture, wherein the given architecture includes neurons organized in layers and/or groups, the instructions, when executed by the one or more computers and/or compute instances, causing the one or more computers and/or compute instances to perform the following steps:
for at least one layer and/or group of neurons, ascertaining a non-linear activation function of the neurons in the layer and/or group from the given architecture;
pre-calculating and storing in a lookup table possible values that can be assumed by the activation function;
generating program code which, for all respective neurons in the layer and/or group respectively:
aggregates inputs of the respective neuron to form an argument of the activation function in accordance with the given architecture,
ascertains an index from the argument, under which an associated value of the activation function is stored in the lookup table for the respective layer and/or group, and
ascertains an output of the respective neuron by retrieving the value from the lookup table with the index.
